(19) United States
(12) Patent Application Publication
(10) Pub. No.: US 2026/0211825 A1
(43) Pub. Date: Jul. 23, 2026

(54) EXECUTION OF VECTOR-MATRIX INSTRUCTIONS IN AN AI ENGINE

(71) Applicant: XILINX, INC., San Jose, CA (US)

(72) Inventors: Juan J. NOGUERA SERRA, San Jose, CA (US); Baris OZGUL, Dublin (IE); David Patrick CLARKE, Dublin (IE); Francisco BARAT QUESADA, Erembodegem (BE); Stephan MUNZ, Dublin (IE)

(21) Appl. No.: 19/034,300

(22) Filed: Jan. 22, 2025

(51) Int. Cl. G06F 13/28; G06F 9/52

(52) U.S. Cl. CPC G06F 13/28; G06F 9/526

(57) ABSTRACT

Embodiments herein describe a system including a direct memory access (DMA) engine configured to receive first data stored in a local memory and an artificial intelligence (AI) engine configured to receive second data bypassing the DMA engine. The first data includes matrix-matrix instructions and the second data includes vector-matrix instructions. The second data is configured to be directly sent to the AI engine to avoid additional overhead of DMA data transfer latency, reduce memory bandwidth usage, and minimize power consumption.

### TECHNICAL FIELD

Examples of the present disclosure generally relate to artificial intelligence (AI) engines, and, in particular, to executing vector-matrix instructions or operations in an AI engine.

### BACKGROUND

Advances in artificial intelligence (AI) have led to the development of specialized engines capable of performing complex matrix and vector operations. These operations are foundational to machine learning (ML) and deep learning (DL) models, including neural networks, which rely on high-speed computation of large-scale matrix multiplications, vector transformations, and other linear algebra functions. AI engines optimize these operations, enabling rapid and efficient execution of inference and training workloads. AI engines use hardware accelerators, such as graphics processing units (GPUs), and are optimized to handle parallelism, sparse data structures, and non-linear activation functions. AI engines enhance throughput, reduce latency, and minimize power consumption, making them fundamental components in edge devices, data centers, and cloud computing environments.

### SUMMARY

One embodiment described herein is a system including a direct memory access (DMA) engine configured to receive first data stored in a local memory and an artificial intelligence (AI) engine configured to receive second data bypassing the DMA engine. The first data includes matrix-matrix instructions and the second data includes vector-matrix data. The vector-matrix data is configured to be directly sent to the AI engine to avoid additional overhead of DMA data transfer latency, reduce memory bandwidth usage, and minimize power consumption

One embodiment described herein is a method including sending first data stored in a local memory to a direct memory access (DMA) engine and sending second data, bypassing the DMA engine, to an artificial intelligence (AI) engine.

One embodiment described herein is a processor including one or more artificial intelligence (AI) engines, each AI engine configured to receive first data bypassing a direct memory access (DMA) engine. The processor may be a graphics processing unit (GPU).

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a direct memory access (DMA) scheme where only some of matrices are stored in local memory and some matrices are streamed directly into an AI engine, according to an example.

FIG. 2 illustrates a method for streaming vector data directly into the AI engine, according to an example.

FIG. 3 is a block diagram of an accelerator unit (AU) configured to execute workloads for applications running on a processing system, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Matrix and vector operations are foundational to artificial intelligence (AI) and machine learning (ML), providing the mathematical framework for processing and transforming data. These operations facilitate the representation of complex relationships and transformations within neural networks, optimization algorithms, and data analysis techniques.

Matrix multiplication involves two matrices that are multiplied together to produce a third matrix. To multiply two matrices, the number of columns in the first matrix equals the number of rows in the second matrix. Datasets in ML are often represented as matrices, where rows correspond to individual samples (data points) and columns correspond to features (variables). In neural networks, the input to each layer is represented as a matrix, and the weights associated with connections between layers are also represented as matrices. During forward propagation, the input matrix is multiplied by the weight matrix to compute the outputs for the layer. This process allows the network to learn complex functions through the multiplication of matrices across multiple layers. In convolutional neural networks (CNNs), matrix operations are used for convolutions, where a filter (kernel) matrix is applied to input data to extract features.

Vector multiplication can refer to several types of operations, including the dot product and cross product. The dot product of two vectors produces a scalar (single number). The dot product measures the cosine of the angle between the two vectors and is used to determine orthogonality, similarity, and projections. The dot product is used in ML algorithms to measure the similarity between feature vectors. The dot product quantifies how closely aligned two vectors are, which is fundamental in algorithms like support vector machines and k-nearest neighbors. The cross product of two vectors produces a new vector that is perpendicular to both vectors. Vector operations are prevalent in AI/ML for computing weighted sums.

Matrix and vector operations can be performed by a functional unit. A functional unit is a component of a computer’s architecture that performs a specific operation, such as addition, subtraction, multiplication, or more complex functions like matrix multiplication or vector operations.

Matrix and vector operations are consequential for AI/ML methodologies, enabling efficient data manipulation and transformation. By utilizing these mathematical frameworks, ML models can learn from data, make predictions, and optimize their performance across a wide array of applications. In AI engines, efficient handling of matrices is beneficial for performing computationally intensive operations such as matrix multiplication, vector transformations, and tensor computations. A common approach involves transferring the matrices to a direct memory access (DMA) unit that communicates directly with the AI engine. This process ensures high-speed data transfer and minimizes computational overhead on the processor itself. However, it needs both matrices to be stored in the system’s local memory, where they can be read by the processor.

The reliance on local memory for storing and accessing matrices introduces significant challenges. AI workloads often deal with large-scale matrices, and accessing this data from local memory repeatedly consumes substantial power. Local memory access, while faster than accessing external memory, involves energy-intensive operations due to the need to maintain high-frequency read/write cycles and mitigate latency. This power overhead is exacerbated by the need to read both matrices independently and often redundantly, increasing the demand on the local memory subsystem.

Moreover, local memory capacity is often limited, demanding frequent data swapping for matrices that exceed the available memory size. This swapping introduces further inefficiencies, such as increased latency and additional power consumption for data movement. For applications involving real-time processing or high-throughput computation, these inefficiencies can become a bottleneck, undermining the performance gains provided by the AI engine.

In view of such challenges, the example embodiments present a method and system for streaming at least some matrices directly into the AI engine. In particular, in one example, vector data are streamed directly into the AI engine, whereas matrix data are provided directly to the DMA unit or engine via a local memory. The opposite may also be true. The beneficial aspect is that the streaming mechanism focuses solely on enabling direct data flow, regardless of the data’s format or structure. This is accomplished by changing the matrix x matrix (or matrix-matrix) operations performed in the AI engine to vector x matrix (vector-matrix) instructions. Instead of storing two matrixes in local memory in the AI engine, only one matrix is stored in the local memory while vectors from the other matrix are streamed to the AI engine. This process, of having some data travel directly to the AI engine, saves power since streaming data uses less power than reading from the local memory (e.g., static random access memory (SRAM)). In other words, the lack of memory reads and stores to the local memory results in reduced power consumption.

Stated differently, the vector-matrix data bypass the DMA engine and is sent directly to the AI engine. Vector-matrix operations involve relatively simpler computational workloads compared to matrix-matrix operations. By sending the vector-matrix data directly to the AI engine, the system avoids the additional overhead of DMA data transfer latency and reduces memory bandwidth usage. The AI engine is employed for high-speed computations and excels in performing operations such as vector-matrix multiplications. Sending vector-matrix data directly to the AI engine allows the use of multiply-accumulate (MAC) units optimized for vector-matrix operations. By bypassing the DMA engine, the vector-matrix data are processed entirely by the AI engine, minimizing power-hungry memory transactions and reducing the overall energy footprint.

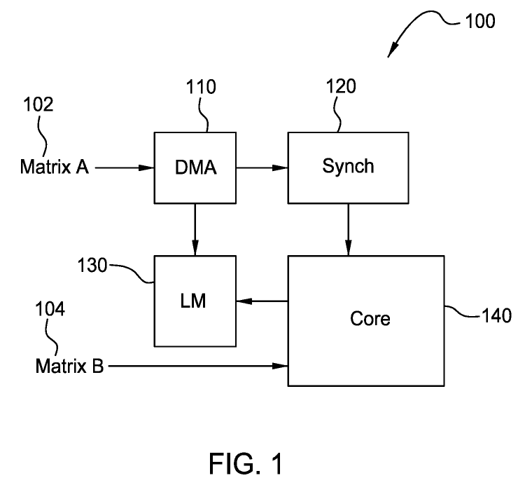

FIG. 1 illustrates a direct memory access (DMA) scheme where only some of matrices are stored in local memory and some matrices are streamed directly into an AI engine, according to an example.

In the system 100, a first matrix 102 (Matrix A) is provided to a DMA engine 110 and a second matrix 104 (Matrix B) is provided to the AI engine core 140. The DMA engine 110 communicates with a synchronization circuit 120 and local memory (LM) 130.

The DMA engine 110 is a specialized hardware component that manages DMA operations. The DMA engine 110 automates the process of transferring data between memory and peripheral devices (or between different memory locations) without the direct involvement of a central processing unit (CPU). The DMA engine 110 is responsible for initiating, managing, and completing data transfers, making the process faster and more efficient than CPU-managed transfers.

As such, the DMA engine 110 autonomously controls the data transfer between a source and a destination. The DMA engine 110 takes over the job of the CPU in managing these transfers, freeing up the CPU for other tasks. The DMA engine 110 calculates the addresses for both the source and the destination of the data, handles any addressing complexities (e.g., memory paging), and ensures data is moved at the correct time. This can be performed in various modes (e.g., burst mode or single mode) based on the data size and requirements. After the DMA transfer is completed, the DMA engine 110 can trigger an interrupt to notify the CPU that the transfer is done. This ensures the CPU doesn’t need to actively wait or poll for the transfer to complete, improving overall system efficiency.

The AI engine core 140 is a specialized processing unit or component within a computing architecture designed specifically for executing AI tasks. The AI engine core 140 is optimized for various AI workloads, including machine learning (ML), deep learning (DL), and data inference. The AI engine core 140 accelerates the execution of AI algorithms, particularly those involving large-scale data processing and complex mathematical computations, such as matrix multiplications, vector operations, and convolutions. The AI engine core 140 supports parallel processing capabilities, allowing it to execute multiple computations simultaneously. This is beneficial for handling the large datasets and complex calculations common in AI workloads. In one example, the AI engine core 140 may include a register file and one or more functional units.

The synchronization circuit 120 is used to notify the AI engine core 140 when a computation or data transfer or transaction is complete. The synchronization circuit 120 wakes up the processor to handle post-completion tasks. For example, the synchronization circuit 120 may generate an interrupt signal upon transaction completion. The interrupt is sent to the processor to notify the processor that the transaction is complete.

The DMA engine 110 accesses the LM 130 for efficient data retrieval for computation, for high-speed data transfers, for minimizing external memory bottlenecks, for supporting parallel operations, and for facilitating synchronization with the AI engine core 140 via the synchronization circuit 120. Once the DMA engine 110 writes in the LM 130, the DMA engine 110 releases a lock using the synchronization circuit 120 to allow the AI engine core 140 to access the first data. The first data may be referred to as matrix data.

The LM 130 serves as the staging area for matrices, vectors, and other data structures used by the AI engine core 140. The DMA engine 110 accesses the LM 130 to fetch the data that will be processed by the AI engine core 140. By accessing the LM 130 directly, the DMA engine 110 eliminates the need for the processor to perform repetitive data transfer tasks, allowing the processor to focus on higher-level operations and control. The LM 130 has lower latency and higher bandwidth compared to external memory. The DMA engine 110 uses this high-speed access to transfer large blocks of data more efficiently, which is beneficial for maintaining the throughput requirements of AI workloads. By accessing the LM 130, the DMA engine 110 ensures that data is delivered to the AI engine core 140 at a rate that matches its processing speed, minimizing idle times. Moreover, accessing external memory, such as dynamic random access memory (DRAM), is slower and more power-intensive than accessing the LM 130. By staging data in the LM 130, the system can reduce the frequency of external memory accesses. The DMA engine 110 can pre-fetch data from external sources into local memory in bulk, ensuring the AI engine core 140 has continuous access to the data it needs while minimizing the performance penalties associated with external memory. Also, the LM 130 serves as a buffer for synchronizing data between the DMA engine 110 and the AI engine core 140. This allows the DMA engine 110 to prepare the data in the correct format and order needed by the AI engine core 140 while also handling any data dependencies. Access to the LM 130 ensures that the AI engine core 140 processes data in a seamless, synchronized manner.

However, in systems involving matrix and vector computations, it is often inefficient to send all data through the DMA engine 110 before they reach the AI engine core 140. Instead, offloading certain data, particularly vector-matrix data, directly to the AI engine core 140 can provide substantial performance and efficiency benefits. This selective routing or redirecting of data allows for better utilization of computational resources and improved system scalability. As such, vector x matrix (vector-matrix) data of the second matrix 104 (Matrix B) are forwarded or streamed directly to the AI engine core 140.

A matrix × vector instruction refers to a computational operation where a matrix is multiplied by a vector. This is a common operation in many AI/ML algorithms, particularly in neural networks, signal processing, and other linear algebra tasks. The operation involves taking a matrix (a two-dimensional array of numbers) and multiplying it by a vector (a one-dimensional array of numbers), resulting in another vector. For example, in AI/ML models, particularly in neural networks, matrix × vector operations are frequently used to apply weight matrices to input data.

By bypassing the DMA engine 110 for certain matrix data, such as vector-matrix multiplications, the system 100 significantly reduces the volume of data that needs to be moved through the DMA engine 110. Vector-matrix operations usually involve smaller data payloads than full matrix-matrix operations. By routing such data directly to the AI engine core 140, bypassing the LM 130, local memory access and DMA bandwidth usage are minimized, freeing resources for other operations.

Vector-matrix operations are computationally simpler and usually complete faster than full matrix-matrix computations. Sending such data directly to the AI engine core 140 eliminates the overhead of staging and transferring data through the DMA engine 110, resulting in lower overall latency. This is advantageous in real-time applications where quick responses are beneficial, such as edge AI.

Vector-matrix operations involve fewer computational resources compared to matrix-matrix multiplications. By isolating and processing these smaller-scale operations directly on the AI engine core 140, the system 100 can make more efficient use of its computation pipelines. This approach improves throughput and allows the AI engine core 140 to process such data concurrently, boosting overall system performance.

Reducing reliance on the DMA engine 110 for vector-matrix operations translates to lower energy consumption. The DMA engine 110 involves power-intensive memory access and data transfer operations. Directly processing vector-matrix computations on the AI engine core 140 avoids this extra power overhead, making the system more energy-efficient, which is beneficial in battery-powered or power-constrained environments. In other words, the lack of memory reads and stores to the LM 130 results in reduced power consumption.

Many ML and optimization algorithms involve iterative updates that rely on frequent vector-matrix computations. For instance, gradient-based learning methods in AI frameworks often perform repeated vector-matrix multiplications during each step. By handling such data directly in the AI engine core 140, the system 100 can efficiently support such iterative workloads without the delays associated with repeated DMA transfers.

As such, changing operations processed by the AI engine core 140 to emphasize vector-matrix operations enhances the system by reducing latency, improving resource utilization, lowering power consumption, and streamlining computation. This selective processing model ensures that both the DMA engine 110 and AI engine core 140 are used in their optimal roles, resulting in a more balanced and efficient computational architecture.

In another example, the matrix-matrix data and the vector-matrix data can be sent via DMA or via streaming. Even though the vector-matrix data has been described as being sent directly to the AI engine core 140, the reverse may occur too. That is, the vector-matrix data may be sent to the DMA and the matrix-matrix data may be sent directly to the AI engine core 140. Thus, any type of data may be selected to be directly sent to the AI engine core 140. This interchangeability is possible because neither DMA nor streaming inherently depends on the data type. They only need the physical or logical descriptors of data sources and destinations, treating everything as “blocks of data.” This decoupling of data format from the transfer mechanism provides versatility and supports various computational workflows.

As such, streaming data directly into the AI engine core is an architectural feature that significantly improves efficiency by bypassing the need for local memory interactions. In traditional systems, data is written to local memory before being read back by the AI engine core for processing. This introduces latency and increases power consumption due to the additional memory access cycles. By contrast, streaming allows data to flow directly from its source to the AI engine core, reducing these overheads.

The elimination of intermediate memory operations offers several advantages. One benefit is the simplification of the data path. When data is streamed directly into the AI engine core, there is no need for additional logic to manage memory buffers or resolve access conflicts. This streamlined approach improves the overall system design and reduces the potential for errors or inefficiencies related to memory management. Further, it allows for a more predictable data flow, which is advantageous in systems with stringent performance requirements.

The ability to send vectors, matrices, or other data types through streaming is secondary to this fundamental efficiency. The beneficial aspect is that the streaming mechanism focuses solely on enabling direct data flow, regardless of the data’s format or structure. By decoupling the transfer method from the data type, the architecture ensures that the processing core can handle incoming data with minimal latency and maximum throughput, achieving optimal performance for a wide range of applications.

Therefore, performing vector-matrix operations in the AI engine core 140 provides several advantages.

The AI engine core 140 is purpose-built for matrix and vector computations. The AI engine core 140 includes specialized hardware accelerators, such as multiply-accumulate (MAC) units and optimized pipelines, designed to perform vector-matrix operations at high speed. In contrast, the DMA engine 110 is employed for efficient data transfer rather than computation. Offloading vector-matrix operations to the AI engine core 140 ensures that these tasks are executed using optimized hardware, resulting in faster and more efficient processing.

Performing computations in the AI engine core 140 consumes less power compared to executing them indirectly via the DMA engine 110. When the DMA engine 110 accesses the LM 130 for vector-matrix operations, the energy cost includes multiple memory access cycles, data staging, and potential overhead for managing data alignment. In the AI engine core 140, the computations are performed in-place using local, high-speed buffers and optimized arithmetic units, reducing the number of memory accesses and overall power consumption. In other words, the lack of memory reads and stores to the local memory results in reduced power consumption.

The DMA engine 110 is used to load the data in the LM 130 for the AI engine core 140 to use or to read the data that the AI engine core 140 produced and send the data to another location. The AI engine core 140 reads the data multiple times from the LM 130. The purpose of avoiding the LM 130 is to not perform any data reuses. Thus, data does not need to be written to the LM 130, which is intermediate storage. When data is needed only once for computation, avoiding reuse eliminates the overhead of storing and fetching it from the LM 130.

Vector-matrix operations use structured and predictable data access patterns. The AI engine core 140 can use its internal memory hierarchies and optimized computation pipelines to handle these patterns more efficiently. In contrast, the DMA engine 110 relies on external control logic and local memory interactions, adding complexity and increasing the chance of bottlenecks or data misalignment.

By streaming vectors or vector data, the AI engine core 140 can focus on performing computations while the data is being delivered. This improves resource utilization since the AI engine core 140 is continuously fed with data to process, without being idle waiting for memory access.

Streaming data directly into the AI engine core 140 reduces the need for large amounts of local memory to store vectors or matrices. This minimizes the memory footprint, freeing up space for other important data or computations within the AI engine core 140.

Streaming allows the AI engine core 140 to handle larger datasets without needing to load the entire dataset into local memory at once. Instead, data can be streamed in as needed, allowing for more scalable solutions. This is useful in large AI models or when processing large input data, where memory limitations may otherwise constrain performance.

Streaming vectors directly into the AI engine core 140 allows for better pipelining of operations. While one set of data is being processed, the next can be streamed in, ensuring a continuous flow of operations. This enhances parallelism and allows the AI engine core 140 to perform multiple operations simultaneously without waiting for data loads.

Moreover, streaming the matrix data directly into the AI engine instead of staging it through DMA and LM provides significant energy savings and improved performance. DMA controllers consume energy during data fetching (retrieving data from external memory) and data movement (writing to local memory). Skipping the DMA eliminates this energy overhead, which can be significant in high-bandwidth, data-intensive operations like matrix computations. Saving the matrix into LM involves energy for each memory write operation. Loading the matrix from local memory into the AI engine requires energy for each memory read operation. Direct streaming of data bypasses these memory accesses entirely, reducing both read and write power consumption. The benefits include elimination of redundant transfers, smaller data path activation, and improved power efficiency as there are no intermediate memory accesses, there are fewer circuits activated during direct streaming, and the AI engine processes the data as it arrives, making the computation almost immediate. Further, this eliminates the need for a larger LM, which reduces chip area and power requirements. Further, direct streaming of certain data ensures a steady flow of data, allowing the AI engine to operate at its maximum computational throughput without stalling.

As such, having the data (e.g., Matrix B) avoid the DMA engine 110 and the LM 130 is advantageous as the data is available to computation units without waiting for staging or DMA transfer to be complete. This also eliminates buffer-related delays associated with the DMA engine 110. Stated differently, the data is consumed at the rate is arrives, without waiting for memory staging. As such, how the data (e.g., Matrix B) now travels provides for such benefits and advantages.

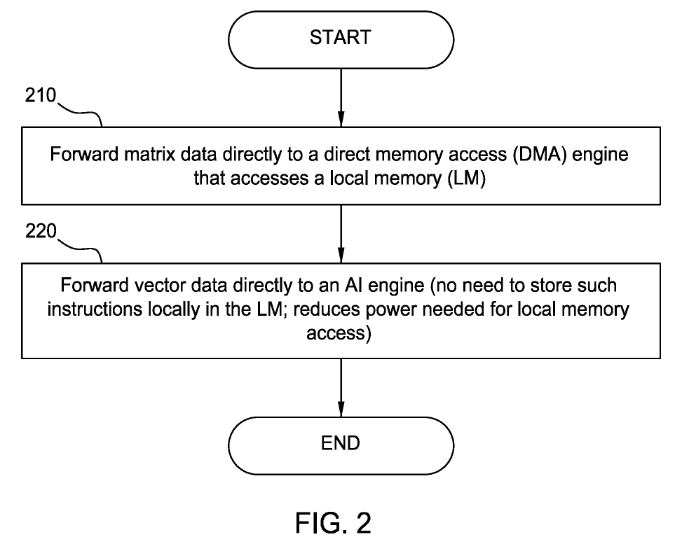

FIG. 2 illustrates a method for streaming vector data directly into the AI engine, according to an example.

At 210, matrix data is sent or forwarded directly to a DMA engine that accesses LM.

At 220, vector data is sent or forwarded directly to an AI engine. Thus, there is no need to store such data locally in the LM and power needed for local memory access is reduced. Storing only one matrix in local memory while streaming vectors from the second matrix into the AI engine core enhances memory efficiency, computational speed, and power savings. Such approach uses efficient memory bandwidth, reduces the memory footprint, and ensures faster, continuous processing of data. Since less data is used in a matrix × vector multiplication compared to matrix × matrix multiplication, the overall power consumption is reduced. By streaming vectors from the second matrix 104 (Matrix B) directly, the system 100 eliminates the need to hold both matrices in local memory at once, freeing up valuable memory resources for other computations or data. Streaming vectors from the second matrix directly into the core allows for more efficient use of memory bandwidth. Instead of loading an entire matrix into memory, which consumes significant bandwidth, only the relevant vector is streamed at each cycle, reducing memory access overhead.

FIG. 2 provides an exemplary configuration for illustrative purposes. The opposite may also be true. That is, the vector data may be sent to the DMA that accesses the LM and the matrix data may be streamed directly to the AI engine core. The ability to send vectors, matrices, or other data types through streaming is secondary to this fundamental efficiency. The beneficial aspect is that the streaming mechanism focuses solely on enabling direct data flow, regardless of the data’s format or structure. By decoupling the transfer method from the data type, the architecture ensures that the processing core can handle incoming data with minimal latency and maximum throughput (regardless of the data type received by the processing core), achieving optimal performance for a wide range of applications.

The evolution from narrow to wider data streams has been a significant enabler of modern AI engine efficiency. These advancements allow data to bypass traditional local memory entirely and be streamed directly into the compute units, as illustrated by the examples. Older architectures used narrow streams (e.g., 32-bit or 64-bit wide), which resulted in limited data throughput for local memory to buffer and batch data for vector instructions. In contrast, modern wide streams are now employed, where the wide streams are hundreds or even thousands of bits wide, enabling high-bandwidth delivery of data directly to AI engines. Examples include 512-bit, 1024-bit, or even 2048-bit wide streams in modern processors and GPUs. Wide streams can carry entire blocks of data (e.g., 8 or 16 floating-point values) in a single cycle. Wider streams allow the AI engine to directly fetch the data it needs for vector operations without intermediate storage in local memory. This eliminates local memory writes and local memory reads. By directly streaming data, vector instructions can operate on data as it arrives, enabling real-time computation. As such, wide streams deliver a higher volume of data per cycle, ensuring that the AI engine is fully utilized and eliminate bottlenecks from narrow interfaces, which often caused stalls waiting for data.

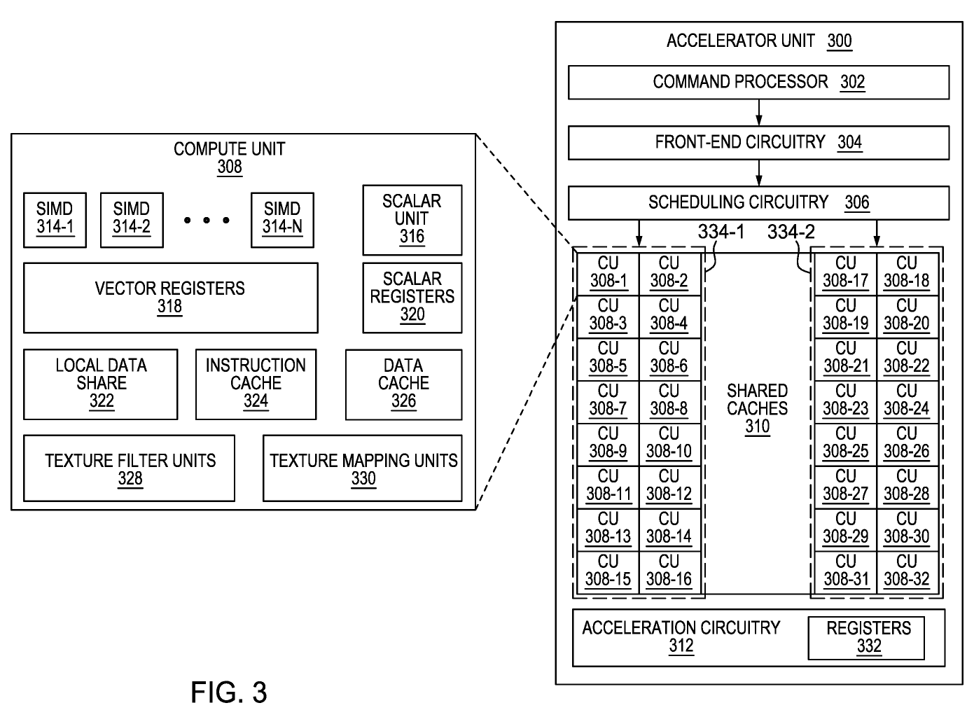

The AI engine core 140 performing the vector-matrix instructions can be incorporated into a GPU or accelerator unit described below with reference to FIG. 3.

FIG. 3 is a block diagram of an accelerator unit (AU) configured to execute workloads for applications running on a processing system, in accordance with some embodiments.

FIG. 3 presents an AU 300 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 300. To perform these workgroups, AU 300 includes one or more vector processors, coprocessors, graphics processing units (GPUs), general-purpose GPUs, non-scalar processors, highly parallel processors, artificial intelligence (AI) processors, inference engines, AI engines, AI engine cores, machine-learning processors, or any combination thereof. As an example, AU 300 includes one or more command processors 302, front-end circuitry 304, scheduling circuitry 306, compute units 308, shared caches 310, and acceleration circuitry 312.

A command processor 302 of AU 300 is configured to receive, from the CPU, a command stream indicating one or more workgroups to be executed. As an example, based on a compute application running on the processing system, the command processor 302 receives a command stream indicating workgroups that involve compute operations such as matrix multiplication, addition, subtraction, and the like to be performed. As another example, based on a graphics application running on the processing system, the command processor 302 receives a command stream indicating workgroups that include draw calls for a scene to be rendered. After receiving a command stream, the command processor 302 parses the command stream and issues respective instructions of the indicated workgroups to front-end circuitry 304, scheduling circuitry 306, or both. As an example, based on a command stream from a graphics application, the command processor 302 issues one or more draw calls to front-end circuitry 304 that includes one or more vertex shaders, polygon list builders, and the like. From the instructions issued from the command processor 302, front-end circuitry 304 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 302, front-end circuitry 304 determines a list of primitives to be rendered for a scene. After determining a list of primitives to be rendered for a scene, the front-end circuitry 304 issues one or more draw calls (e.g., a workgroup) associated with the primitives in the list of primitives to scheduling circuitry 306.

Based on the instructions of the workgroups received from a command processor 302, front-end circuitry 304, or both, scheduler circuitry 306 is configured to provide data indicating threads (e.g., operations for these threads) to be executed for these workgroups to one or more compute units 308. Each compute unit 308 is configured to support the concurrent execution of two or more threads of a workgroup. For example, each compute unit 308 is configured to concurrently execute a predetermined number of threads referred to herein as a “wavefront.” Based on the size of the wavefront of a compute unit 308, scheduler circuitry 306 schedules one or more groups of threads of the workgroup, also referred to herein as “waves,” to be executed by the compute unit 308. As an example, scheduler circuitry 306 first updates one or more registers of a compute unit 308 such that the compute unit 308 is configured to execute a first group of waves of the workgroup. After the compute unit 308 has executed the first group of waves, scheduler circuitry 306 updates one or more registers of the compute unit 308 to schedule a second group of waves of the workgroup to be executed by the compute unit 308. To execute these waves, each compute unit is connected to one or more shared caches 310 that each include a volatile memory, non-volatile memory, or both accessible by one or more compute units 308. These shared caches 310, for example, are configured to store data (e.g., register files, values, operands, instructions, variables) used in the execution of one or more waves, data resulting from the performance of one or more waves, or both. Because a shared cache 310 is accessible by two or more compute units 308, a first compute unit 308 is enabled to provide results from the execution of a first wave to a second compute unit 308 executing a second wave. Though the example embodiment presented in FIG. 3 shows AU 300 as including 32 compute units (308-1 to 308-32), in other implementations, AU 300 can include any number of compute units 308.

Each compute unit 308 includes one or more single instruction, multiple data (SIMD) units 314, a scalar unit 316, vector registers 318, scalar registers 320, local data share 322, instruction cache 324, data cache 326, texture filter units 328, texture mapping units 330, or any combination thereof. A SIMD unit 314 (e.g., a vector processor) is configured to concurrently perform multiple instances of the same operation for a wave. For example, a SIMD unit 314 includes two or more lanes each including an arithmetic logic unit (ALU) and each configured to perform the same operation for the threads of a wave. Though the example embodiment presented in FIG. 3 shows a compute unit 308 including three SIMD units (314-1, 314-2, 314-N) representing an N number of SIMD units, in other implementations, a compute unit 308 can include any number of SIMD units 314. Further, as an example, the size of a wavefront supported by AU 300 is based on the number of SIMD units 314 included in each compute unit 308. To determine the operations performed by the SIMD units 314, each compute unit 308 includes vector registers 318 formed from one or more physical registers of AU 300. These vector registers 318 are configured to store data (e.g., operands, values) used by the respective lanes of the SIMD units 314 to perform a corresponding operation for the wave. Additionally, each compute unit 308 includes a scalar unit 316 configured to perform scalar operations for the wave. As an example, the scalar unit 316 includes an ALU configured to perform scalar operations. To support the scalar unit 316, each compute unit 308 includes scalar registers 320 formed from one or more physical registers of accelerator unit 300. These scalar registers 320 store data (e.g., operands, values) used by the scalar unit 316 to perform a corresponding scalar operation for the wave.

Further, each compute unit 308 includes a local data share 322 formed from a volatile memory (e.g., random-access memory) accessible by each SIMD unit 314 and the scalar unit 316 of the compute unit 308. That is to say, the local data share 322 is shared across each wave concurrently executing on the compute unit 308. The local data share 322 is configured to store data resulting from the execution of one or more operations for one or more waves, data (e.g., register files, values, operands, instructions, variables) used in the execution of one or operations for one or more waves, or both. As an example, the local data share 322 is used as a scratch memory to store results necessary for, aiding in, or helpful for the performance of one or more operations by one or more SIMD units 314. The instruction cache 324 of a compute unit 308, for example, includes a volatile memory, non-volatile memory, or both configured to store the instructions to be executed for one or more waves to be executed by the compute unit 308. Further, the data cache 326 of a compute unit 308 includes a volatile memory, non-volatile memory, or both configured to store data (e.g., register files, values, operands, variables) used in the execution of one or more waves by the compute unit 308. The instruction cache 324, data cache 326, shared caches 310, and a system memory, for example, are arranged in a hierarchy based on the respective sizes of the caches. As an example, based on such a cache hierarchy, a compute unit 308 first requests data from a controller of a corresponding data cache 326. Based on the data not being in the data cache 326, the data cache 326 requests the data from a shared cache 310 at the next level of the cache hierarchy. The caches then continue in this way until the data is found in a cache or requested from the system memory, at which point, the data is returned to the compute unit 308. Additionally, each compute unit 308 includes one or more texture mapping units 330 each including circuitry configured to map textures to one or more graphics objects (e.g., groups of primitives) generated by the compute units 308. Further, each compute unit 308 includes one or more texture filter units 328 each having circuitry configured to filter the textures applied to the generated graphics objects. For example, the texture filter units 328 are configured to perform one or more magnification operations, anti-aliasing operations, or both to filter a texture.

Additionally, to help perform instructions for one or more workgroups, AU 300 includes acceleration circuitry 312. Such acceleration circuitry 312 includes hardware (e.g., fixed-function hardware) configured to execute one or more instructions for one or more workgroups. As an example, acceleration circuitry 312 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 306 is configured to update one or more physical registers 332 of AU 300 associated with the hardware. In some cases, AU 300 includes one or more compute units 308 grouped into one or more shader engines 334. Referring to the embodiment presented in FIG. 3, for example, AU 300 includes compute units 308-1 to 308-16 grouped in a first shader engine 334-1 and compute units 308-17 to 308-32 grouped in a second shader engine 334-2. Such shader engines 334, for example, are configured to execute one or more workgroups (e.g., one or more compute kernels) for an application and include one or more compute units 308, graphics processing hardware (e.g., primitive assemblers, rasterizers), one or more shared caches 310, render backends, or any combination thereof. Though the embodiment presented in FIG. 3 shows AU 300 as including two shader engines (334-1, 334-2), in other implementations, AU 300 can include any number of shader engines (334-1, 334-2).

Further, changing matrix × matrix operations to matrix × vector operations in AI/ML applications can provide several benefits, especially in terms of computational efficiency, power consumption, and memory usage.

Matrix × matrix multiplication involves significantly more operations than matrix × vector multiplication. When switching to matrix × vector operations, the number of calculations is reduced because one dimension of the operation is simplified.

In scenarios where real-time processing is employed, such as inference in ML models or real-time data analysis, matrix × vector operations can be executed faster than matrix × matrix operations. This is because they involve fewer operations, which can result in lower latency for tasks like processing sensor data or making predictions in real-time AI applications.

Many AI/ML tasks, such as neural network inference, involve operations like matrix × vector multiplications (e.g., applying weights to input data or hidden layers in neural networks). Optimizing for matrix × vector operations can be beneficial for these specific workloads, allowing hardware to be tailored to common patterns found in these applications. This is useful in fully connected layers of neural networks, where the input data is often treated as vectors and is multiplied by weight matrices.

For hardware designers, focusing on matrix × vector operations can simplify the design of accelerators or functional units, as fewer multipliers and adders may be needed. This can lead to reduced chip area, less complex control logic, and potentially higher clock speeds or more efficient parallelization.

Moreover, matrix × vector operations are easier to parallelize in certain architectures (e.g., AI engine cores or GPUs) because they include fewer interactions between elements. This allows for more efficient use of the hardware’s parallel processing capabilities, leading to better scaling as the number of processing units increases.

In conclusion, the examples provide for streaming at least some matrices directly into the AI engine. In particular, in one example, vector data is streamed directly into the AI engine, whereas matrix data is provided directly DMA via a local memory. The reverse may also be true. The beneficial aspect is that the streaming mechanism focuses solely on enabling direct data flow, regardless of the data’s format or structure. This is accomplished by changing the matrix x matrix operations performed in the AI engine to matrix x vector instructions. Instead of storing two matrixes in local memory in the AI engine, only one matrix is stored in the local memory while vectors from the other matrix are streamed to the AI engine. This process saves power since streaming data uses less power than reading from the local memory (e.g., SRAM). In other words, the lack of memory reads and stores to the local memory results in reduced power consumption. In another example, both vector and matrix data is streamed directly into the AI engine bypassing the LM altogether.

Stated differently, the vector-matrix data bypass the DMA engine and are sent directly to the AI engine. Vector-matrix operations involve relatively simpler computational workloads compared to matrix-matrix operations. By sending the vector-matrix operations directly to the AI engine, the system avoids the additional overhead of DMA data transfer latency and reduces memory bandwidth usage. The AI engine is employed for high-speed computations and excels in performing operations such as vector-matrix multiplications. Sending vector-matrix data directly to the AI engine allows the use of MAC units optimized for vector-matrix operations. By bypassing the DMA engine, the vector-matrix data are processed entirely by the AI engine, minimizing power-hungry memory transactions and reducing the overall energy footprint. As such, the lack of memory reads and stores in the LM provides for reduced power consumption.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system comprising:
a direct memory access (DMA) engine configured to receive first data stored in a local memory; and
an artificial intelligence (AI) engine configured to receive second data bypassing the DMA engine.

2. The system of claim 1, wherein the first data includes matrix data and the second data includes vector data.

3. The system of claim 1, wherein the second data is configured to be directly sent to the AI engine to avoid additional overhead of DMA data transfer latency, reduce memory bandwidth usage, and minimize power consumption.

4. The system of claim 1, wherein a synchronization circuit is electrically connected to the AI engine to notify the AI engine when DMA data transfer is complete and to generate an interrupt signal upon completion of the DMA data transfer.

5. The system of claim 4, wherein, once the DMA engine writes the first data in the local memory, the DMA engine releases a lock using the synchronization circuit to allow the AI engine to access the first data.

6. The system of claim 1, wherein the second data is not stored in the local memory.

7. The system of claim 1, wherein the second data is streamed directly to the AI engine.

8. A method comprising:
sending first data stored in a local memory to a direct memory access (DMA) engine; and
sending second data, bypassing the DMA engine, to an artificial intelligence (AI) engine.

9. The method of claim 8, wherein the first data includes matrix data and the second data includes vector data.

10. The method of claim 8, wherein the second data is configured to be directly sent to the AI engine to avoid additional overhead of DMA data transfer latency, reduce memory bandwidth usage, and minimize power consumption.

11. The method of claim 8, wherein a synchronization circuit is electrically connected to the AI engine to notify the AI engine when DMA data transfer is complete and to generate an interrupt signal upon completion of the DMA data transfer.

12. The method of claim 11, wherein, once the DMA engine writes the first data in the local memory, the DMA engine releases a lock using the synchronization circuit to allow the AI engine to access the first data.

13. The method of claim 8, wherein the second data is not stored in the local memory.

14. A processor comprising:
one or more artificial intelligence (AI) engines, each AI engine configured to receive first data bypassing a direct memory access (DMA) engine.

15. The processor of claim 14, wherein the processor is a graphics processing unit (GPU).

16. The processor of claim 14, wherein second data stored in a local memory is received by the DMA engine.

17. The processor of claim 16, wherein the second data includes matrix data and the first data includes vector data.

18. The processor of claim 17, wherein the first data is configured to be directly sent to the AI engine to avoid additional overhead of DMA data transfer latency, reduce memory bandwidth usage, and minimize power consumption.

19. The processor of claim 18, wherein a synchronization circuit is electrically connected to the AI engine and wherein, once the DMA engine writes the first data in the local memory, the DMA engine releases a lock using the synchronization circuit to allow the AI engine to access the second data.

20. The processor of claim 14, wherein the first data is not stored in a local memory.
